(19) United States
(12) Patent Application Publication
(10) Pub. No.: US 2018/0165734 A1
(43) Pub. Date: Jun. 14, 2018

(54) NETWORKING PLATFORM SYSTEM AND METHOD

(71) Applicants: Samantha Paulina Yoannou, Toronto (CA); Mary Anderson, Toronto (CA)

(72) Inventors: Samantha Paulina Yoannou, Toronto (CA); Mary Anderson, Toronto (CA)

(21) Appl. No.: 15/373,772

(22) Filed: Dec. 9, 2016

(51) Int. Cl. G06Q 30/06; G06Q 50/00; G06Q 20/10; G06Q 20/40

(52) U.S. Cl. CPC G06Q 30/0613; G06Q 50/01; G06Q 2220/00; G06Q 20/401; G06Q 20/10

(57) ABSTRACT

The networking platform system consists of a platform server including a database and related software. The platform server may have several software modules that include: a registration module for approving qualified users, a messaging module to assist in connecting users, a transaction module to help pay for featured services, a graphical display module to allow for quick and easy searching, and a contract management module for users to engage in binding work agreements. Combined, these software modules are useful for allowing providers (under the age of 40) of specialized labor and local consumers to connect and forge binding contracts for freelance work without fears of being priced out of their respective markets.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of electronic commerce and more specifically relates to organization of skill-based services.

### 2. Description of Related Art

The online market for services is one of the largest components of developed economies, encompassing everything from high-end professional services such as medical and legal services to low-wage services such as fast food attendants. A significant fraction of the services market is devoted to what have come to be known as “knowledge workers”. While these include doctors, lawyers, accountants, architects, and members of other recognized professions, it also includes many specialist worker categories that are not as well known. Examples include web developers, editors, translators, artists, performers, and the like. A suitable solution is desired.

U.S. Pub. No. 2009/0210282 to Elenbaas, et al. relates to an online work management system with job division support. The described online work management system with job division support includes an online work management system provides a marketplace for multiple job owner and workers. The job owners provide a job description that defines task. The job description may be processed to generate task descriptions that may be published for workers' application. The task descriptions specify the qualification or restrictions for workers to have the task assigned. The online work management system also provides various functions supporting coordination and management of task assignment such as determining the trust level of the user's identity, search the tasks or workers, monitoring the progress of job, managing payment to workers, training and testing the workers, evaluating the review by the job owners, and generation of surveys.

### BRIEF SUMMARY OF THE INVENTION

In view of the foregoing disadvantages inherent in the known electronic commerce art, the present disclosure provides a novel networking platform system. The general purpose of the present disclosure, which will be described subsequently in greater detail, is to provide a networking platform system.

A networking platform system is disclosed herein. The networking platform system includes a platform server having a database and related software. The platform server may have several embedded software modules or programs that include: a registration module for approving qualified users based upon provided background information, a messaging module allowing approved users to communicate with each other, a transaction module that allows users to pay for featured services, a graphical display module for quick and easy searching of included content, a location software module that is useful for determining the proximity of potential applicants and users alike, and a contract management module for approved users to engage in binding work agreements.

According to another embodiment, a method of using the networking platform system is also disclosed herein. The method of using the networking platform system includes the steps of registering a successful application on the networking platform system, searching for a featured service of a provider, connecting with the designated provider on the networking platform system, contracting a featured service from the provider, and paying for the featured service on the networking platform system.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a networking platform system, constructed and operative according to the teachings of the present disclosure.

FIG. 1 is a perspective view of the networking platform system during an ‘in-use’ condition, according to an embodiment of the disclosure.

FIG. 2 is a diagram illustrating components of the networking platform system of FIG. 1, according to an embodiment of the present disclosure.

FIG. 3 is a conceptual diagram illustrating the workflow creation of a featured task on the networking platform system of FIG. 1, according to an embodiment of the present disclosure.

FIG. 4 is a front view of the networking platform system of FIG. 1, according to an embodiment of the present disclosure.

FIG. 5 is a flow diagram illustrating a method of use for the networking platform system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to electronic commerce and more particularly to a networking platform system as used to improve the electronic commerce systems.

The networking platform system may be an online platform for freelance professionals under 40 to display their portfolios and connect with clients who may be seeking high quality and affordable contract workers within major cities around the globe. The present system relates generally to the field of online platforms, which may be referred to as “Milly: an agency and networking platform for local millennials”.

The platform allows users to source a diverse variety of high quality contract and freelance work, such as web development, copywriting, or film editing (to name a few), from the portfolios of professionals hand picked by the app's developers. The platform allows contract and freelance laborers under age 40 within Toronto and within other cities around the world to present their work, without fear of being priced out by competitive external markets, and ensures that all contracts forged through the application are binding to both the provider and client. The platform connects people living within the same city, easily facilitating seamless communication or face to face interactions between providers and their clients—in other words, it also acts as a networking tool in an otherwise tough city to create long lasting working relationships in. The networking platform system is useful to create the tangible outputs of successfully completed applications and binding contracts registered through the system.

The present invention is an online application, which requires users who wish to have their services represented on the platform to go through an application process to be represented. The application also allows professionals (or other start ups) looking to source contract work to browse the portfolios of a variety of freelance or contract service providers. Consumers may be permitted to search through registered service providers and related services offered on the networking platform system. Once those using the app system to source work wish to connect with a labourer, they must create an account to do so. All correspondence between contract labourers and their potential clients that is conducted through the apps messaging service will be retained by the app for a period of at least 5 years, and contracts created through the app's service will be considered binding. Additionally, the embedded communication modules may service communications between providers of services for purposes of allowing service-based swaps to be contracted in lieu of monetary payments. Physical payments between the two parties will also be facilitated through the app.

The networking platform system may further include a location software module that is useful for determining the proximity of potential applicants and users alike. The location verification feature may be included to ensure that the networking platform system is being used for purposes of connecting local talent to consumers within the same city. Alternate embodiments may display maps identifying the location of users that may rely on the location software module to facilitate directions and mapping arrangements. Another alternate embodiment may allow for direct feedback to be provided and registered through the networking platform system by consumers, providers, and system administrators alike. The feedback generated may be used for promotional purposes and for allowing system users to make informed decisions about future service contracts.

The merit of this service is twofold. For labourers who present their work on the service (specifically for those starting out their careers), they benefit from having a seamless, simple way to exhibit their abilities and services to a wide audience of users with the added benefit of knowing that any contract formed through the app will be binding. For potential clients, the benefit lies in their ability to search through a large body of skilled, vetted, and affordable contract labour providers who live in their vicinity, without having to resort to searching other online buying and selling platforms.

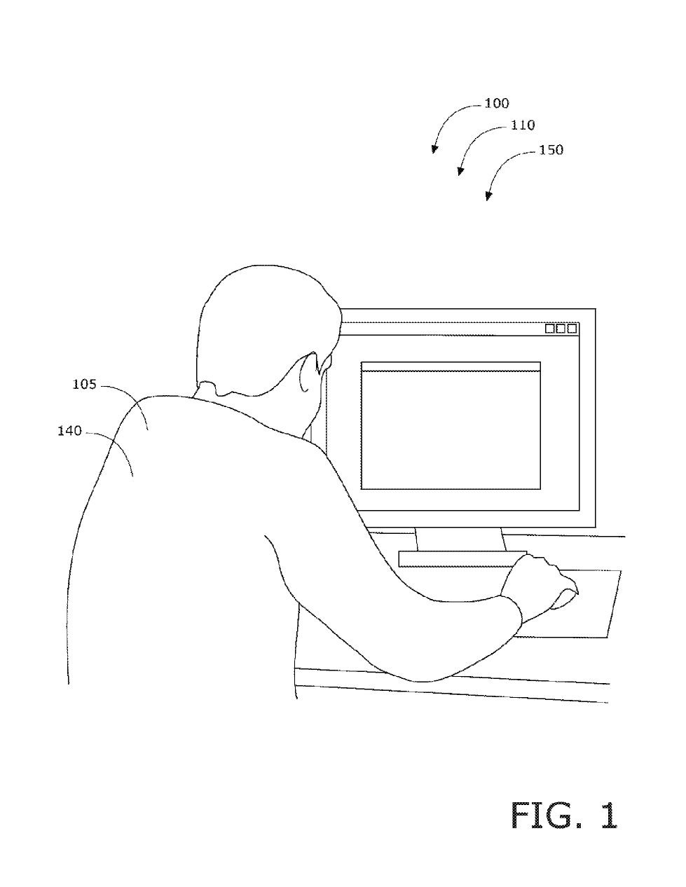

Referring now more specifically to the drawings by numerals of reference, there is shown in FIGS. 1-4, various views of a networking platform system 100. FIG. 1 shows a networking platform system 100 during an ‘in-use’ condition 150, according to an embodiment of the present disclosure. Here, the networking platform system 100 may be beneficial for use by a user 140 and potential applicant 5 to display their work portfolio and connect with clients. As illustrated, the networking platform system 100 may include platform server 110.

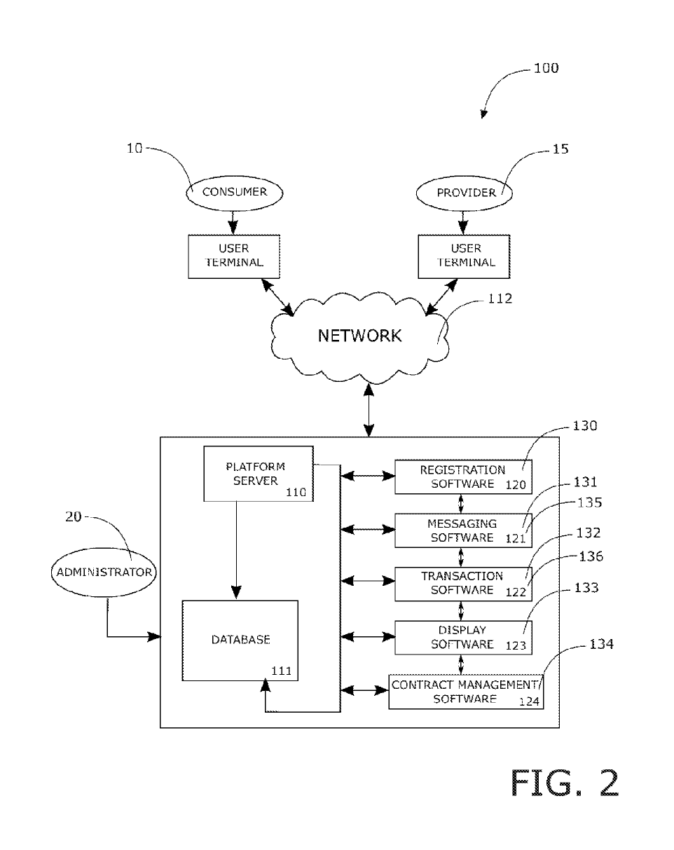

FIG. 2 shows a diagram illustrating components of the networking platform system 100 of FIG. 1, according to an embodiment of the present disclosure. As above, the networking platform system 100 may include a platform server 110 having a database 111 that is connected to a network 112 and further operated by an administrator 20. The platform server 110 may be used as a command center for several software modules that comprise an application for operating and managing the networking platform system 100. The first module included is the registration software module 120 that is useful for providing a method for receiving and processing 130 information collected from a consumer 10 and a provider 15. The next featured module is the messaging software module 121 which features a method for networking platform system-based communication 131 that may be used as a means for sending and receiving 135 information on the networking platform system 100. Further still is the transaction software module 122 having a method for securely receiving and processing 132 transaction information including a means for encrypted transmission 136 of that information. Additionally, the platform server 110 may include a display software module 123 having a graphical interface 133 for displaying information provided by a consumer 10 and a provider 15. Finally, the platform server 110 may also feature a contract management software module 124 that may serve as a method for matching 134 a consumer 10 to a provider 15.

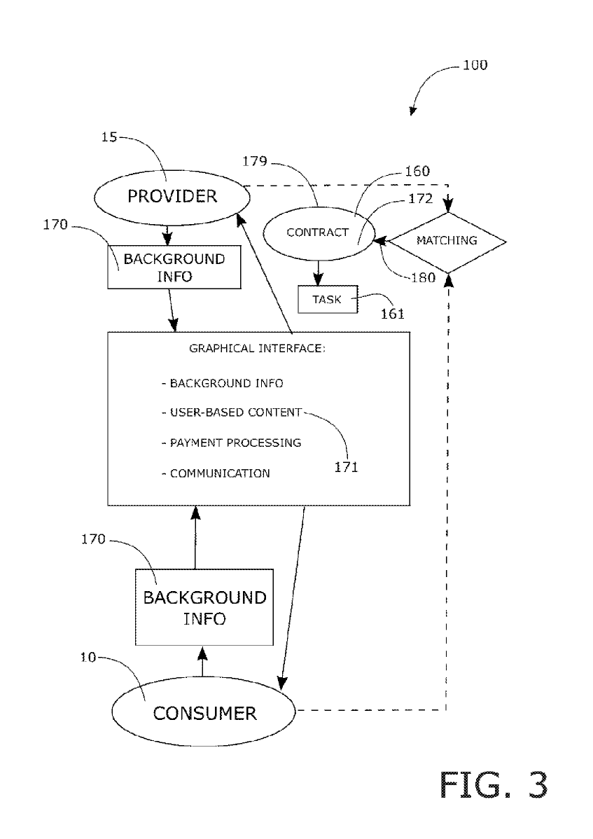

FIG. 3 is a conceptual diagram illustrating the workflow creation of a binding contract 179 based upon a featured service 172 on the networking platform system 100 of FIG. 1, according to an embodiment of the present disclosure. Here, a provider 15 of a featured service 172 may upload their background information 170 including information regarding the featured service 172 that they provide onto the networking platform system 100 for easy viewing and searching by a consumer 10 that may be interested in contracting that featured service 172. The consumer 10 may search through the user-based content 171 and contact the provider 15 about hiring them to perform the featured service 172 in question. Upon a successful matching 180 of a consumer 10 to a provider 15, a binding contract 179 may be formed including an agreed upon price 160 for the featured service 172 that includes at least a first task 161 to be completed by the provider 15.

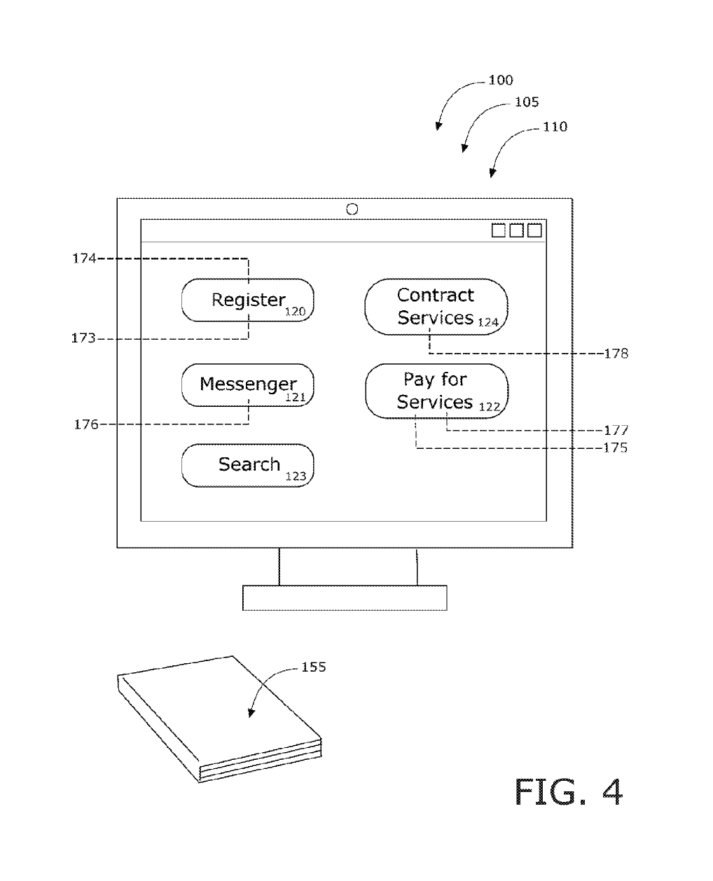

FIG. 4 is a front view of the networking platform system 100 of FIG. 1 on a platform server 110, according to an embodiment of the present disclosure. According to one embodiment, the networking platform system 100 may be arranged as a kit 105. In particular, the networking platform system 100 may further include a set of instructions 155. The set of instructions 155 may detail functional relationships in relation to the structure of the networking platform system 100 (such that the networking platform system 100 can be used, maintained, or the like, in a preferred manner). FIG. 4 details a screen view illustrating various software modules that may be included on the networking platform system 100. A user may select the registration software module 120 in order to create a successful application 173 and upload a portfolio submission 174 detailing an example of their previous work. There may also be an option to select the messaging software module 121 where users may exchange text and image communication transmissions 176. Additionally, the display software module 123 and contract management software module 124 may be used on the networking platform system 100 to search and view the quoted price 178 listed for various services provided therein. Finally, according to one embodiment of the networking platform system 100, there may also be a transaction software module 122 included for users to provide payment information 175 and furnish payments 177.

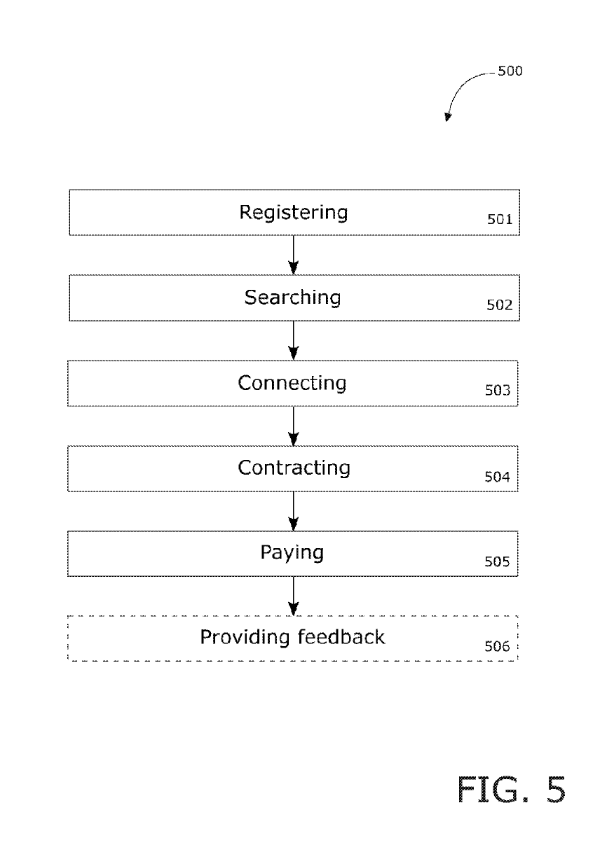

FIG. 5 is a flow diagram illustrating a method 500 for the networking platform system 100, according to an embodiment of the present disclosure. In particular, the method 500 for using the networking platform system 100 may include one or more components or features of the networking platform system 100 as described above. As illustrated, the method for using 500 may include the steps of: step one 501, registering a successful application 173 on the networking platform system 100; step two 502, searching for a featured service 172 of a provider 15; step three 503, connecting with the designated provider 15 on the networking platform system 100; step four 504, contracting a featured service 172 from the provider 15; and step five 505, paying for the featured service 172 on the networking platform system 100.

It should be noted that step six 506, providing feedback regarding the featured service 172 and provider 15, is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for electronic commerce systems (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A networking platform system, the system comprising:
a platform server including a database;
a registration software module featuring a method for receiving and processing background information about a potential applicant;
a messaging software module featuring a method for system-based communication;
a transaction software module featuring a method for securely receiving and processing payments;
a display software module featuring a graphical interface for representing user-based content and background information; and
a contract management software module featuring a method for matching a consumer of a featured service and a provider of said featured service.

2. The system of claim 1, wherein said platform server is connected to a network.

3. The system of claim 1, wherein said potential applicant includes said consumer of said featured service and alternately said provider of said featured service.

4. The system of claim 3, wherein an administrator is able to reject and disqualify said potential applicant at any time including before and alternately after a successful application has been processed.

5. The system of claim 4, wherein said administrator is an employee of said system.

6. The system of claim 1, wherein said background information is stored on said database.

7. The system of claim 6, wherein said background information includes at least one item from the group consisting of a name, date of birth, address, portfolio submission, payment information, and telephone number.

8. The system of claim 1, wherein said method for system-based communication includes a means for sending and receiving text and image communication transmissions.

9. The system of claim 1, wherein said method for securely receiving and processing said payments provides a means for encrypted transmission of said payment information for processing said payments.

10. The system of claim 1, wherein said user-based content and background information includes at least one item from the group consisting of said name, said date of birth, said address, said portfolio submission, said telephone number, said featured service, a testimonial, and a quoted price.

11. The system of claim 10, wherein said user-based content is able to be sorted and searched through by a user of said graphical interface.

12. The system of claim 10, wherein said user-based content can only be contracted for service by said consumer upon completion of said successful application.

13. The system of claim 1, wherein said contract management software module generates a binding contract based upon a successful matching of said consumer and said provider.

14. The system of claim 1, wherein said binding contract includes an agreed upon price for said featured service.

15. The system of claim 13, wherein said successful matching is determined based upon mutual agreement of said consumer and said provider of said featured service and approval by said administrator of said system.

16. The system of claim 1, wherein said featured service includes at least a first task to be completed by said provider.

17. A networking platform system, the system comprising:
a platform server including a database;
a registration software module featuring a method for receiving and processing background information about a potential applicant;
a messaging software module featuring a method for system-based communication;
a transaction software module featuring a method for securely receiving and processing payments;
a display software module featuring a graphical interface for representing user-based content and information;
a contract management software module featuring a method for matching a consumer of a featured service and a provider of said featured service;
wherein said platform server is connected to a network;
wherein said potential applicant includes said consumer of said featured service and alternately said provider of said featured service;
wherein an administrator is able to reject and disqualify said potential applicant at any time including before and alternately after a successful application has been processed;
wherein said administrator is an employee of said system;
wherein said background information is stored on said database;
wherein said background information includes at least one item from the group consisting of a name, date of birth, address, portfolio submission, payment information, and telephone number;
wherein said method for system-based communication includes a means for sending and receiving text and image communication transmissions;
wherein said method for securely receiving and processing payments provides a means for encrypted transmission of information for processing said payments;
wherein said user-based content and information includes at least one item from the group consisting of said name, said date of birth, said address, said portfolio submission, said telephone number, said featured service, a testimonial, and a quoted price;
wherein said user-based content is able to be sorted and searched through by a user of said graphical interface;
wherein said user-based content can only be contracted for service by said consumer upon completion of said successful application;
wherein said contract management software module generates a binding contract based upon a successful matching of said consumer and said provider;
wherein said binding contract includes an agreed upon price for said featured service;
wherein said successful matching is determined based upon mutual agreement of said consumer and said provider of said featured service and approval by said administrator of said system;
wherein said featured service includes at least a first task to be completed by said provider.

18. The system of claim 17, further comprising set of instructions; and
wherein the system is arranged as a kit.

19. A method of using the networking platform system, the method comprising the steps of:
registering a successful application on the networking platform system;
searching for a featured service of a provider;
connecting with the designated provider on the networking platform system;
contracting a featured service from the provider;
paying for the featured service on the networking platform system.

20. The method of claim 19, further comprising the steps of:
providing feedback regarding the featured service and provider.
